(19) United States
(12) Patent Application Publication
(10) Pub. No.: US 2015/0199419 A1
(43) Pub. Date: Jul. 16, 2015

(54) INFORMATION PROCESSING APPARATUS, INFORMATION PROCESSING METHOD AND NON-TRANSITORY COMPUTER READABLE MEDIUM

(71) Applicant: FUJI XEROX CO., LTD., Tokyo (JP)

(72) Inventor: Katsuhiko ITONORI, Yokohama-shi (JP)

(73) Assignee: FUJI XEROX CO., LTD., Tokyo (JP)

(21) Appl. No.: 14/669,676

(22) Filed: Mar. 26, 2015

Related U.S. Application Data
(63) Continuation of application No. PCT/JP2013/065425, filed on Jun. 4, 2013.

(30) Foreign Application Priority Data
Oct. 18, 2012 (JP) 2012-230863

(51) Int. Cl. G06F 17/30

(52) U.S. Cl. CPC G06F 17/30598

(57) ABSTRACT

There is provided an information processing apparatus. A setting unit sets certain data as an element of a certain data group. A data attribute acquisition unit analyzes the certain data, and acquires data attribute information about attributes of the certain data on the basis of an analysis result. A group attribute acquisition unit acquires group attribute information about attributes of another data group. An association unit associates, if a comparison result between the group attribute information about attributes of the other data group and the data attribute information about attributes of the certain data satisfies a predetermined condition, the group attribute information with the certain data. A unit associates, with the certain data, group attribute information about attributes of a higher-level data group of the other data group if the comparison result satisfies the condition.

### CROSS-REFERENCE TO RELATED APPLICATIONS

This is a continuation of International Application No. PCT/JP2013/065425 filed on Jun. 4, 2013, and claims priority from Japanese Patent Application No. 2012-230863, filed on Oct. 18, 2012.

### TECHNICAL FIELD

The present invention relates to an information processing apparatus, an information processing method and a non-transitory computer readable medium.

### SUMMARY

According to an aspect of the exemplary embodiments of the present invention, there is provided an information processing apparatus including: a setting unit that sets certain data as an element of a certain data group; a data attribute acquisition unit that analyzes the certain data, and acquires data attribute information about attributes of the certain data on the basis of an analysis result; a group attribute acquisition unit that acquires group attribute information about attributes of another data group; an association unit that associates, if a comparison result between the group attribute information about attributes of the other data group and the data attribute information about attributes of the certain data satisfies a predetermined condition, the group attribute information with the certain data; and a unit that associates, with the certain data, group attribute information about attributes of a higher-level data group of the other data group if the comparison result satisfies the condition.

### BRIEF DESCRIPTION OF DRAWINGS

Exemplary embodiments of the present invention will be described in detail based on the following figures, wherein:

FIG. 1 is a diagram illustrating the configuration of an information processing apparatus;

FIG. 2 is a functional block diagram illustrating a group of functions realized in the information processing apparatus;

FIG. 3 is a diagram illustrating a hierarchical structure;

FIG. 4 is a diagram illustrating a hierarchical structure;

FIG. 5 is a diagram illustrating file system management information;

FIG. 6 is a flowchart illustrating a process executed in the information processing apparatus;

FIG. 7 is a diagram illustrating an associated-folder table;

FIG. 8 is a diagram illustrating an associated-folder table; and

FIG. 9 is a flowchart illustrating a process executed in the information processing apparatus.

### DETAILED DESCRIPTION

Hereinafter, an exemplary embodiment of the present invention will be described in detail with reference to the accompanying drawings.

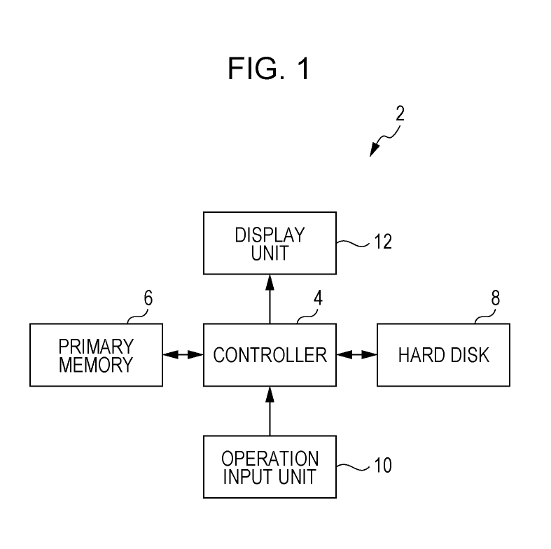

FIG. 1 is a diagram illustrating the structure of an information processing apparatus 2 according to the exemplary embodiment of the present invention. According to the present exemplary embodiment, the information processing apparatus 2 is a computer provided to a member of the human resources department of a company, and includes a controller 4, a primary memory 6, a hard disk 8, an operation input unit 10, and a display unit 12. The controller 4 is a microprocessor that performs various types of information processing in accordance with a file system management program stored in the primary memory 6. The primary memory 6 is implemented by a ROM and a RAM, and stores the file system management program. The file system management program is read from a computer-readable information recording medium (for example, DVD (registered trademark)—ROM) and is stored in the primary memory 6. Note that the file system management program may be downloaded over a network and be stored in the primary memory 6.

The hard disk 8 stores various types of information. The operation input unit 10 includes a mouse and a keyboard, and outputs an operation signal indicating an operation performed by the human resources staff member to the controller 4. The display unit 12 is a display, and displays information in accordance with an instruction from the controller 4.

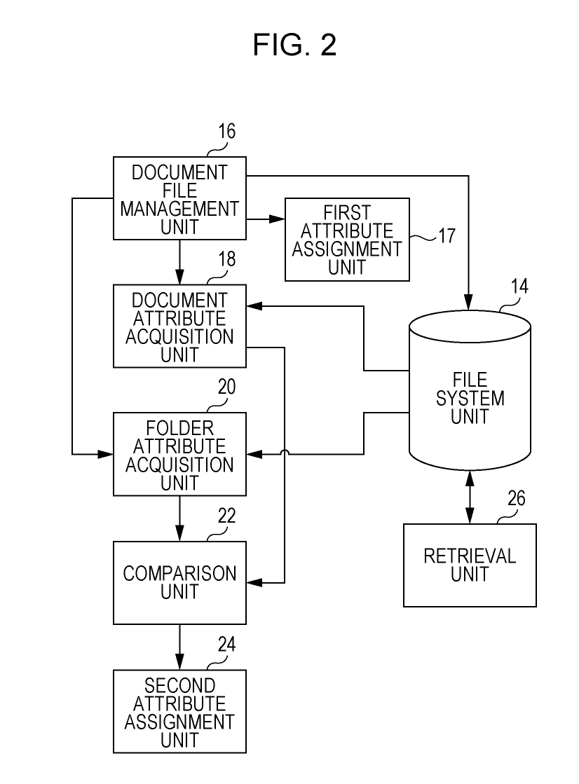

FIG. 2 is a functional block diagram illustrating a group of functions realized in the information processing apparatus 2. As illustrated in FIG. 2, in the information processing apparatus 2, a file system unit 14, a document file management unit 16, a first attribute assignment unit 17, a document attribute acquisition unit 18, a folder attribute acquisition unit 20, a comparison unit 22, a second attribute assignment unit 24, and a retrieval unit 26 are realized. The file system unit 14 is implemented by the hard disk 8. The functions excluding the file system unit 14 are implemented by the controller 4 that operates in accordance with the file system management program.

### File System Unit

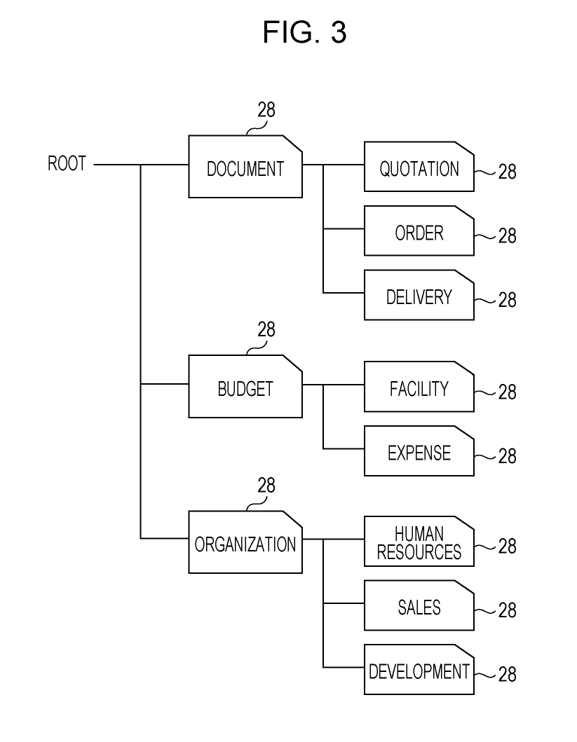

The file system unit 14 stores hierarchical data representing a hierarchical structure including plural folders present on the file system. Each folder corresponds to a “data group”. The hierarchical data includes the folder name of each folder present on the file system. In the hierarchical data, each folder name is associated with the folder name of a higher-level folder. FIG. 3 illustrates the hierarchical structure represented by the hierarchical data. A graphic denoted by the reference sign “28” represents a folder. The folder name is displayed inside the graphic representing the folder. Note that the top of the hierarchy is called a root.

Further, the file system unit 14 stores plural document files present on the file system. A document file is document data including text. A document file corresponds to “data”. Although the case where document data corresponds to “data” will be described herein, data other than document data (for example, image data) may correspond to “data”.

Further, the file system unit 14 also stores the identification (hereinafter referred to as the document ID) of each document file present on the file system.

### Document File Management Unit

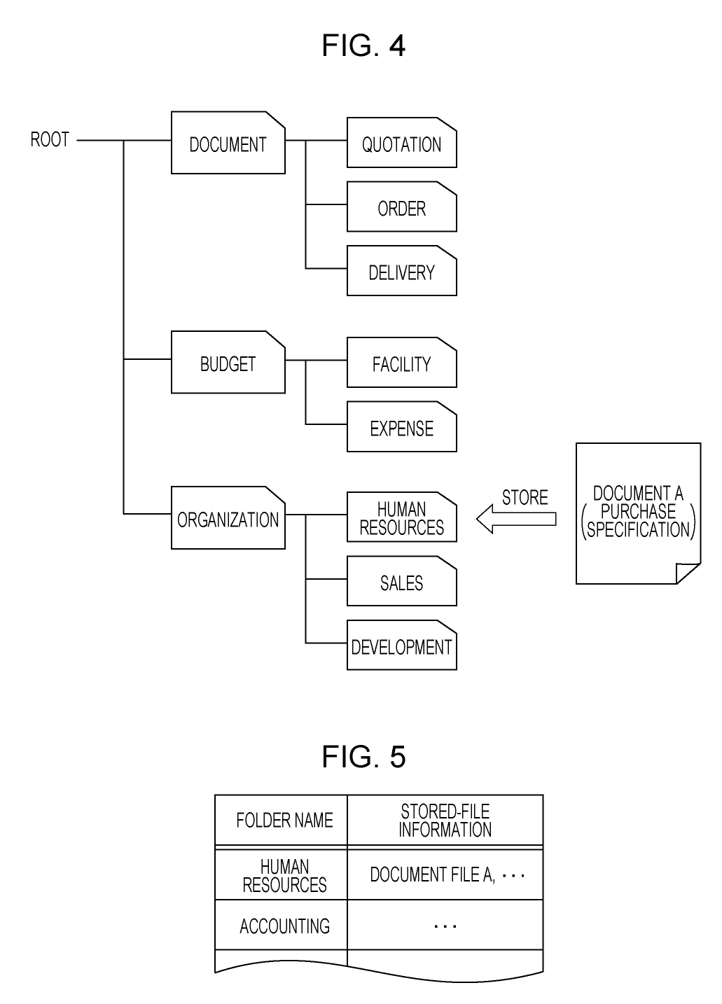

The human resources staff member classifies and organizes the document files on the file system. That is, the human resources staff member performs a predetermined storing operation so as to store a document file in a folder corresponding to its category. For example, as illustrated in FIG. 4, the human resources staff member stores a document file of a document A, which is a purchase specification indicating items purchased by the human resources department, in a “human resources” folder provided as a folder related to the human resources department. This is because the document file of the document A is a document file related to the human resources department. When the storing operation is performed, then in the information processing apparatus 2 the document file management unit 16 associates the document ID of the document file with the folder name of the folder storing the document file. More specifically, file system management information indicating document files stored in each of the folder on the file system is stored in the hard disk 8. FIG. 5 illustrates file system management information. As illustrated in FIG. 5, the file system management information stores, in association with the folder name of each folder on the file system, stored-file information including the document ID of a document file stored in that folder. The document file management unit 16 adds the document ID of a document file to the stored-file information associated with the folder name of a destination folder, and thereby stores the document file in the destination folder. For example, in the case of storing the document file of the document A in the “human resources” folder, the document file management unit 16 adds the document ID of the document file of the document A to the stored-file information associated with the folder name of the “human resources” folder.

It may be said that the folder name represents the category of a document file stored in the folder. Accordingly, it may also be said that, when a storing operation is performed, the document file management unit 16 sets the document file as a document file belonging to a category represented by the name of the folder storing the document file. A folder name corresponds to “group attribute information”.

Note that, when needed, the human resources staff member changes the storage location of a document file already stored in a certain folder so as to move the document file to another folder. That is, the human resources staff member performs a predetermined moving operation so as to move a document file already stored in a folder to another folder. As in the case where a storing operation is performed, when the moving operation is performed, then in the information processing apparatus 2 the document file management unit 16 associates the document ID of the document file with the name of the folder storing the document file, that is, the name of the folder to which the document file is moved. In this case, the document file management unit 16 removes the association of the document ID of the document file with the name of the folder from which the document file is moved. That is, the document file management unit 16 deletes the document ID of the document file from the stored-file information associated with the name of the folder from which the document file is moved.

In the manner described above, the human resources staff member organizes document files on the file system by performing a storing operation and a moving operation. Further, the human resources staff member selects a folder corresponding to the category of a document file that the staff member wishes to refer to, and thereby finds the document file. For example, when the human resources staff member wishes to refer to the document file of the document A, the staff member selects the “human resources” folder.

There are cases in which even if the human resources staff member selects a folder corresponding to the category of a document file that the staff member wishes to refer to, the document file is not found. For example, in the case where the classification criteria have changed, even if the human resources staff member selects a folder corresponding to the current category of a document file that the staff member wishes to refer to, since the document file is stored in a folder corresponding to a previous category, the document file is not found. For instance, even if the human resources staff member wishes to the document file of the document A and selects an “accounting” folder in consideration of the current classification criteria that classify documents related to accounting into the “accounting” folder (see FIG. 3), since the document file of the file A is stored in the “human resources” folder in accordance with previous classification criteria that classify documents related to the human resources department into the “human resources” folder, the document file is not found.

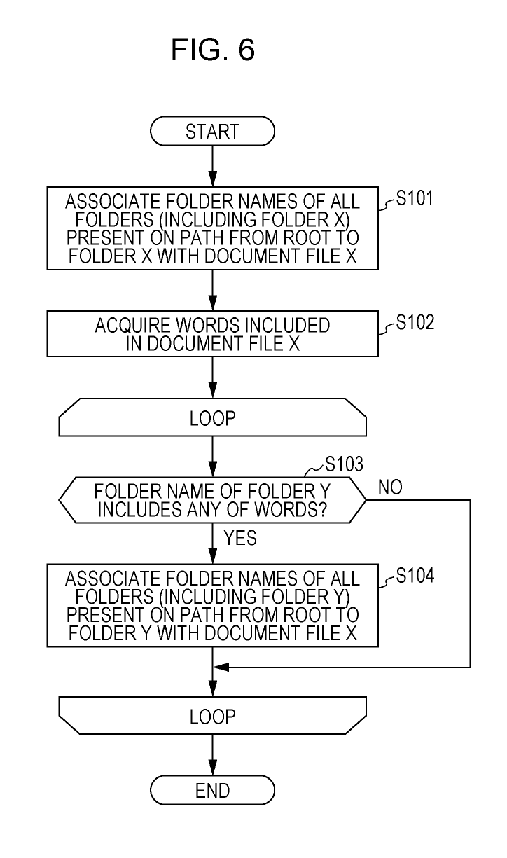

In view of this, in the information processing apparatus 2, the first attribute assignment unit 17, the document attribute acquisition unit 18, the folder attribute acquisition unit 20, the comparison unit 22, the second attribute assignment unit 24, and the retrieval unit 26 are realized such that the human resources staff member is able to easily find the document file that the staff member wishes to refer to even if the classification criteria change. FIGS. 6 and 9 are flowcharts each illustrating a process executed by these functions in the information processing apparatus 2. Hereinafter, these functions will be described with reference to FIGS. 6 and 9. Note that in the following description, “selecting a folder” is referred to as “opening a folder”.

### First Attribute Assignment Unit

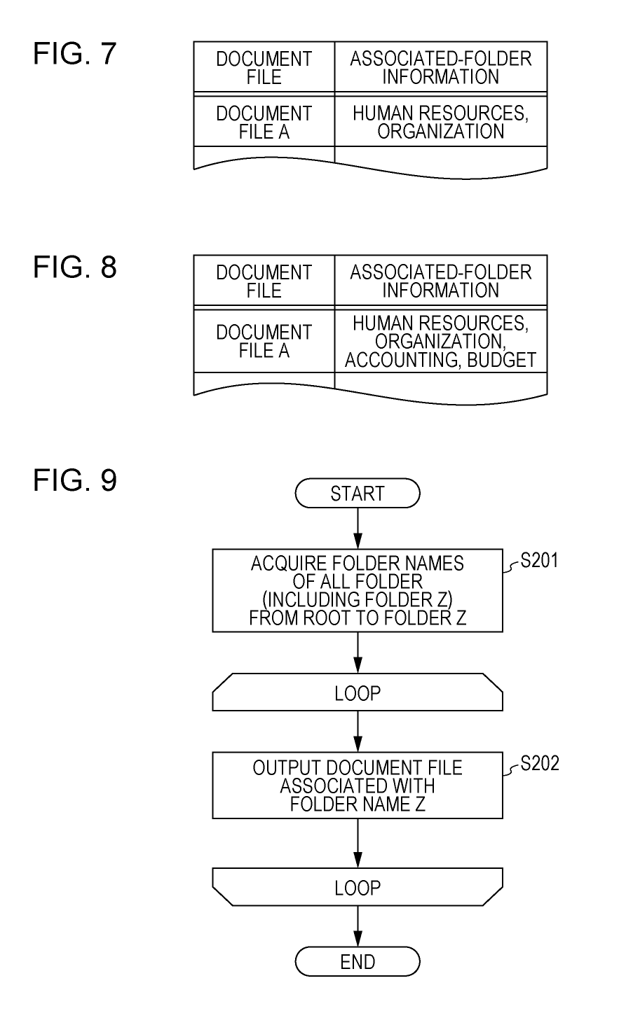

First, a description will be given of FIG. 6. FIG. 6 illustrates a process executed when a storing operation or a moving operation is performed. That is, in the case where the document file management unit 16 stores a certain document file (hereinafter referred to as a document file X) in a certain folder (hereinafter referred to as a folder X) as the result of a storing operation or a moving operation, the first attribute assignment unit 17 acquires, from the file system unit 14, the folder names of all the folders (including the folder X) from the root to the folder X, and associates the acquired folder names with the document ID of the document file X (S101). In the case of the present exemplary embodiment, an associated-folder table indicating a folder to which each of the document files on the file system relates is stored in the hard disk 8. FIG. 7 illustrates the associated-folder table. As illustrated in FIG. 7, the associated-folder table stores, in association with the document ID of each document file on the file system, associated-folder information including the folder name of a folder related to the document file. In S101, the first attribute assignment unit 17 adds the folder names of all the folders from the root to the folder X to the associated-folder information associated with the document ID of the document file X, and thereby associates these folder names with the document ID of the document file X. FIG. 7 illustrates the associated-folder table in the case where the document file of the document A is stored in the “human resources” folder.

Note that in S101, the first attribute assignment unit 17 may associate only the folder name of the folder X with the document ID of the document file X.

### Document Attribute Acquisition Unit

Then, the document attribute acquisition unit 18 reads the document file X from the file system unit 14. After that, the document attribute acquisition unit 18 analyzes the document file X, and acquires attribute information about the attributes of the document file X. In this example, the document attribute acquisition unit 18 acquires words (for example, nouns) included in the text in the document file X as attribute information (S102). Each of the words acquired in S102 corresponds to “data attribute information”. Note that in S102, in place of words included in the text in the document file X, the document attribute acquisition unit 18 may acquire the file name of the document file X as attribute information.

After S102, each of folders that are not on the path from the root to the folder X is selected from among the files present on the file system. Each time a folder is selected, the steps of S103 and S104 are performed for the selected folder (hereinafter referred to as a folder Y).

### Folder Attribute Acquisition Unit and Comparison Unit

That is, the folder attribute acquisition unit 20 acquires the attribute information about the attributes of the folder Y. After that, the comparison unit 22 compares the attribute information about the attributes of the folder Y with the attribute information acquired by the document attribute acquisition unit 18, and determines whether the comparison result satisfies a predetermined condition (S103). More specifically, the folder attribute acquisition unit 20 acquires the folder name of the folder Y. After that, the comparison unit 22 determines whether the folder name of the folder Y includes any of the words acquired by the document attribute acquisition unit 18 (S103).

### Second Attribute Assignment Unit

If the folder name of the folder Y includes any of the words acquired by the document attribute acquisition unit 18 (YES in S103), the second attribute assignment unit 24 associates the folder names of all the folders (including the folder Y) from the root to the folder Y with the document file X (S104). That is, in S104, the second attribute assignment unit 24 adds the folder names of all the folders from the root to the folder Y to the associated-folder information associated with the document ID of the document file X. Note that in S104, the second attribute assignment unit 24 may associate only the folder name of the folder Y with the document file X.

On the other hand, if the folder name of the folder Y does not include any of the words acquired by the document attribute acquisition unit 18 (NO in S103), the next folder is selected as the folder Y, and the step of S103 and the step that follows are performed again.

FIG. 8 illustrates the associated-folder table in the case where the document file of the document A is stored in the “human resources” folder. The document A is a purchase specification indicating items purchased by the human resources department, and also is a document related to accounting. Therefore, the folder name of the “accounting” folder is associated with the document ID of the document file of the document A.

### Retrieval Unit

A description will be given of a process illustrated in FIG. 9. The process illustrated in FIG. 9 is executed in the case where any of the folders present on the file system is opened. That is, the retrieval unit 26 refers to the hierarchical data, and acquires the folder names of all the folders (including the opened folder (hereinafter referred to as a folder Z) from the root to the folder Z (S201). Note that in S201, the retrieval unit 26 may acquire only the file name of the folder Z.

Then, the retrieval unit 26 selects each of the folder names acquired in step S201. Each time a folder name is selected, the retrieval unit 26 performs the step of S202 for the selected folder name (hereinafter referred to as the folder name Z). That is, the retrieval unit 26 refers to the associated-folder table, and specifies associated-folder information including the folder name Z. After that, the retrieval unit 26 reads a document file identified by the document ID associated with the specified associated-folder information from the file system unit 14, and outputs the read document file (S202). In the case of the present exemplary embodiment, the retrieval unit 26 outputs a thumbnail image of the read document file. Further, in S202, the retrieval unit 26 also outputs a thumbnail image of the document file stored in the folder Z.

As illustrated in FIG. 8, the folder name of the “accounting” folder is associated with the document file of the document A stored in the “human resources” folder. Accordingly, if the “accounting” folder is opened, not only the document file originally stored in the “accounting” file, but also the document file of the document A is output. Thus, when the human resources staff member wishes to refer to the document file of the document A, the staff member is able to easily find the document file of the document A without opening the “human resources” folder.

### Summary

As described above, in the information processing apparatus 2, when a document file is stored in a folder, the second attribute assignment unit 24 associates, with the document file, another folder related to the document file (see S103 and S104 of FIG. 6). Further, when a folder is opened, the retrieval unit 26 outputs a document file with which the opened folder is associated (see S202 of FIG. 9). This reduces the time and effort it takes for the human resources staff member to find a document file that has been classified in accordance with previous classification criteria and from a previous viewpoint, when the staff member wishes to refer to the document file.

Further, in the information processing apparatus 2, the first attribute assignment unit 17 associates not only the other folder, but also the folder storing the document file, with the document file (see S101 of FIG. 6). Therefore, even if a document file that the human resources staff member wishes to refer to has been classified in accordance with previous classification criteria and its storage location has been changed many times, the time and effort it takes for the staff member to find the document file is reduced.

Further, in the information processing apparatus 2, the first attribute assignment unit 17 associates, with the document file, a higher-level folder of the folder storing the document file. Further, the second attribute assignment unit 24 associates, with the document file, a higher-level folder of the other folder related to the document file (see S101 and S104 of FIG. 6). In addition to this, the retrieval unit 26 outputs not only a document file with which an opened folder is associated, but also a document file associated with the higher-level folder of the opened folder (see S201 and S202 of FIG. 9). This also reduces the time and effort it takes for the human resources staff member to find a document file that has been classified in accordance with previous classification criteria, when the staff member wishes to refer to the document file.

Exemplary embodiments of the present invention are not limited to the exemplary embodiment described above.

For example, the file system unit 14 may be implemented by a database server provided separately from the information processing apparatus 2.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus comprising:
a setting unit that sets certain data as an element of a certain data group;
a data attribute acquisition unit that analyzes the certain data, and acquires data attribute information about attributes of the certain data on the basis of an analysis result;
a group attribute acquisition unit that acquires group attribute information about attributes of another data group;
an association unit that associates, if a comparison result between the group attribute information about attributes of the other data group and the data attribute information about attributes of the certain data satisfies a predetermined condition, the group attribute information with the certain data; and
a unit that associates, with the certain data, group attribute information about attributes of a higher-level data group of the other data group if the comparison result satisfies the condition.

2. The information processing apparatus according to claim 1, further comprising:
a retrieval unit that retrieves, if any of data groups is selected, data with which group attribute information about attributes of the data group is associated.

3. The information processing apparatus according to claim 1, further comprising:
a unit that associates, with the certain data, group attribute information about attributes of the certain data group.

4. The information processing apparatus according to claim 3, further comprising:
a unit that associates, with the certain data, group attribute information about attributes of a higher-level data group of the certain data group.

5. The information processing apparatus according to claim 1, wherein:
the data is document data representing a document;
the data attribute acquisition unit acquires a word included in the certain data as the data attribute information;
the group attribute acquisition unit acquires a name of the other data group as the group attribute information; and
the association unit associates the name of the other data group with the certain data if the word included in the certain data is included in the name of the other data group.

6. An information processing method comprising:
setting certain data as an element of a certain data group;
analyzing the certain data, and acquiring data attribute information about attributes of the certain data attribute information about attributes of the certain data on the basis of an analysis result;
acquiring group attribute information about attributes of another data group;
associating, if a comparison result between the group attribute information about attributes of the other data group and the data attribute information about attributes of the certain data satisfies a predetermined condition, the group attribute information with the certain data; and
associating, with the certain data, group attribute information about attributes of a higher-level data group of the other data group if the comparison result satisfies the condition.

7. A non-transitory computer readable medium storing a program for causing a computer to execute an information processing process, the process comprising:
setting certain data as an element of a certain data group;
analyzing the certain data, and acquiring data attribute information about attributes of the certain data on the basis of an analysis result;
acquiring group attribute information about attributes of another data group;
associating, if a comparison result between the group attribute information about attributes of the other data group and the data attribute information about attributes of the certain data satisfies a predetermined condition, the group attribute information with the certain data; and
associating, with the certain data, group attribute information about attributes of a higher-level data group of the other data group if the comparison result satisfies the condition.
